(19) United States
(12) Patent Application Publication
(10) Pub. No.: US 2008/0106428 A1
(43) Pub. Date: May 8, 2008

(54) Detection apparatus and method for detecting a rotational speed of a fan

(75) Inventors: Hacker Yan, Hu-Nan (CN); Brother Zhong, Hu-Nan (CN); Wind Xia, Hu-Nan (CN)

Correspondence Address: BIRCH STEWART KOLASCH & BIRCH, PO BOX 747, FALLS CHURCH, VA, 22040-0747, US

(73) Assignees: DELTA ELECTRONICS POWER (DONGGUAN) CO., LTD.; DELTA ELECTRONICS, INC.

(21) Appl. No.: 11/724,281

(22) Filed: Mar. 15, 2007

(30) Foreign Application Priority Data
Nov. 6, 2006 (TW) 095141019

(51) Int. Cl. G08B 21/00

(52) U.S. Cl. 340/671; 340/679

(57) ABSTRACT

A detection apparatus and a method for detecting the rotation speed of a fan are disclosed. The detection apparatus comprises a photoelectric sensing unit, a processing unit, and a prompt unit. The photoelectric sensing unit senses the strength of a light beam reflected in response to the rotation of the fan to generate a frequency signal. The processing unit converts the frequency signal into a rotation speed signal, and determines whether the rotation speed falls within a certain range. If yes, the processing unit generates a first prompt signal, from which the prompt unit can show a message of normal operation. If no, the processing unit generates a second prompt signal, from which the prompt unit can show a message of abnormal operation.

This application claims the benefit of priority based on Taiwan Patent Application No. 095141019 filed on Nov. 6, 2006 of which the contents are incorporated herein for reference in their entirety.

### CROSS-REFERENCES TO RELATED APPLICATIONS

Not applicable.

### BACKGROUND OF THE INVENTION

1. Field of the Invention

The present invention relates to a detection apparatus and a method for detecting the rotation speed of a fan; more specifically, relates to a detection apparatus and a method for detecting whether the rotation of a fan is normal according to strength of a light beam reflected by the rotation of the fan.

2. Descriptions of the Related Art

In current technology, the rotation speed of a fan can be used for evaluating the fan's capabilities. The various rotation speeds of each type of fan falls within a certain range. If the rotation speed exceeds the variation range, the fan is abnormal. Current power supplies of computers and servers, etc., are also installed with fans for heat sinking. Because the fan is electrically driven to rotate by the power supply, the rotation speed of the fan is also controlled by the power supply. Thus, detection of the rotation speed of the fan in the power supply can uncover quality problems which may exist in the power supply.

Currently, the rotation speed of the fan in the power supply is detected by human senses. For example, a human could determine the normality of the rotation speed by sensing the resistance of a cable tie that blocks the blades of the fan.

However, there are many drawbacks accompanying these existing detection methods. For example, tester experience can play a large role in accurately and effectively detecting problematic fans.

Consequently, a solution that can detect problematic fans accurately, enhance detection efficiency and speed, and eliminate inaccuracy due to reliance on human senses, is desired.

### SUMMARY OF THE INVENTION

The present invention provides a detection apparatus, which overcomes the drawbacks of the existing technology, for detecting the rotation speed of a fan. As a result, the fan detected by such a detection apparatus has high reliability, high detection effectiveness and speed, and a guaranteed quality.

An objective of this invention is to provide a detection apparatus for detecting a rotation speed of a fan. The detection apparatus comprises a photoelectric sensing unit, a processing unit, and a prompt unit. The photoelectric sensing unit senses strength of a light beam reflected in response to a rotation of the fan to generate a frequency signal. The processing unit converts the frequency signal into a rotation speed signal, and determines whether the rotation speed is within a range in response to the rotation speed signal. If yes, the processing unit generates a first prompt signal, from which the prompt unit can show a message of normal operation. If no, the processing unit generates a second prompt signal, from which the prompt unit can show a message of abnormal operation.

Another objective of this invention is to provide a method for detecting a rotation speed of a fan. The method comprises the following steps: sensing strength of a light beam reflected in response to a rotation of the fan to generate a frequency signal; converting the frequency signal into a rotation speed signal; determining whether the rotation speed is within a range in response to the rotation speed signal; generating a first prompt signal if the rotation speed is within the range; generating a second prompt signal if the rotation speed is not within the range; showing a message of normal operation in response to the first prompt signal; and showing a message of abnormal operation in response to the second prompt signal.

The present invention is capable of detecting the strength of a light beam reflected by the rotation of a fan to generate a frequency signal. The frequency signal is processed to obtain the rotation speed of the fan to determine whether the rotation of the fan is normal. As a result, the present invention enhances detection effectiveness, detection speed, and reduces inaccuracy by relying solely on human senses.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating a first embodiment of the present invention;

FIG. 2 is a schematic diagram illustrating the first embodiment of the present invention; and

FIG. 3 is a flow chart illustrating a second embodiment of the present invention.

### DESCRIPTION OF THE PREFERRED EMBODIMENT

In this specification, the term “according to” or “in response to” is defined as “replying to” or “reacting to.” For example, “according to a signal” and “in response to a signal” means “replying to a signal” or “reacting to a signal” without necessity of direct signal reception.

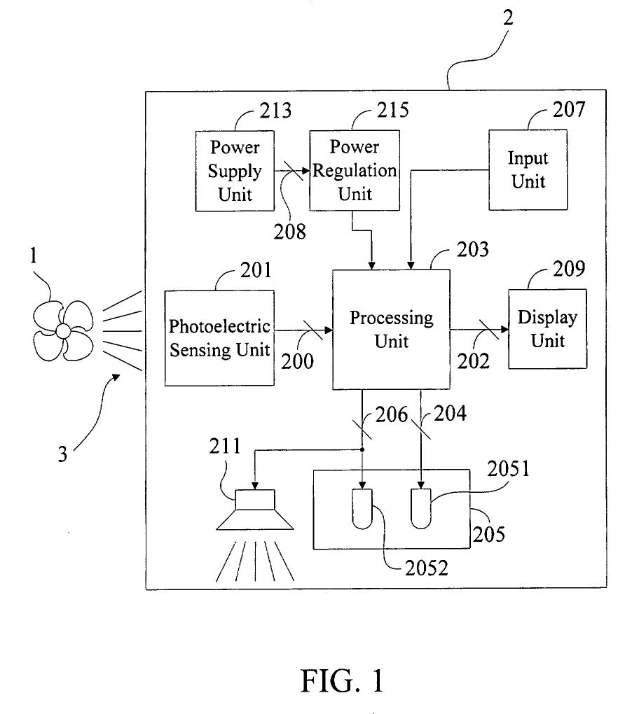

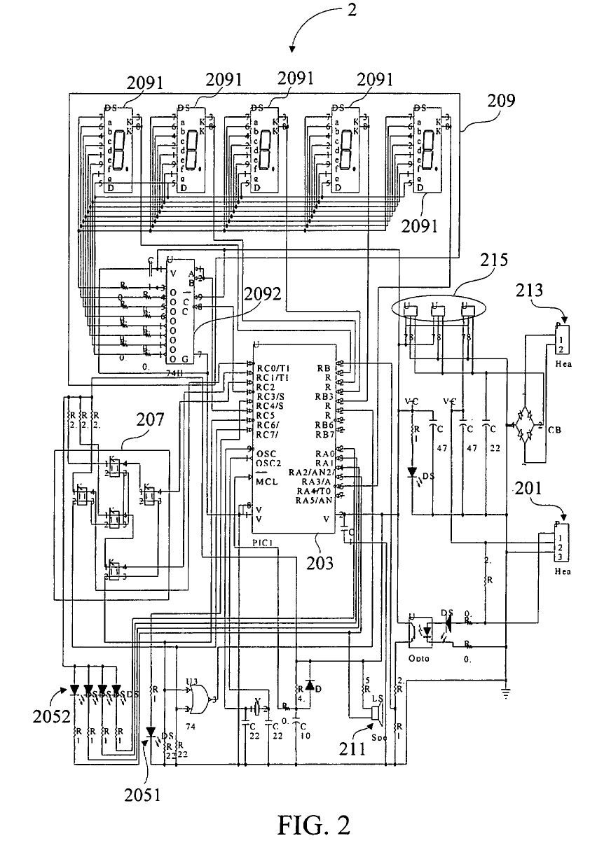

As shown in FIG. 1 and FIG. 2, a first embodiment of the present invention is disclosed. FIG. 1 is a block diagram of the first embodiment, while FIG. 2 is a detailed schematic diagram thereof. The first embodiment of the present invention is a detection apparatus 2 for detecting the rotation speed of a fan 1. The detection apparatus 2 comprises a photoelectric sensing unit 201, a processing unit 203, a prompt unit 205, an input unit 207, a display unit 209, a buzzer 211, a power supply unit 213, and a power regulation unit 215. The photoelectric sensing unit 201 emits a light beam to the fan 1, so that a light beam 3 can be reflected in response to the rotation of the fan 1. The photoelectric sensing unit 201 receives the light beam 3, and generates a frequency signal 200 according to the strength of the light beam 3. The processing unit 203 then converts the frequency signal 200 into a rotation speed signal 202, and determines whether the rotation speed 202 of the fan 1 falls within a certain range. The range can be either predetermined when the detection apparatus 2 is produced by manufacturers, or determined when the user inputs an instruction in the processing unit 203 via the input unit 207. Furthermore, the power supply unit 213 provides power 208. After the power 208 is regulated by the power regulation unit 215, the regulated voltage is supplied to the detection apparatus 2 for operation.

If the rotation speed of the fan 1 falls within the range, the processing unit 203 generates a first prompt signal 204. On the contrary, the processing unit 203 generates a second prompt signal 206 if the rotation speed of the fan 1 fails to fall within the certain range. The prompt unit 205 comprises a first light emitting diode (LED) 2051 and a second LED 2052. If the rotation speed of the fan 1 is determined to be within the range by the processing unit 203, the first LED 2051 is enabled by the first prompt signal 204 to show a message of normal operation message. If the rotational speed of the fan 1 is determined not to be within the range by the processing unit 203, the second LED 2052 is enabled by the second prompt signal 206 to show a message of abnormal operation message. The buzzer 211 is also driven by the second prompt signal 206 to remind users that the fan rotation is abnormal. The display unit 209 receives the rotation signal 202, and displays the rotation speed of the fan 1 in response to the rotation signal 202.

As shown in FIG. 1, the two signal lines are used for transmitting the first prompt signal 204 and the second prompt signal 206, respectively. The present invention does not require that the first prompt signal 204 and the second prompt signal 206 have to be transmitted in separate signal lines. More specifically, the processing unit 203 can be designed to utilize a “high level” and a “low level” of signal for respectively representing whether the fan 1 is normal or abnormal. For example, the high level signal represents the normal operation, while the low level signal represents the abnormal operation. The first LED 2051 lights in response to the high level signal. The second LED 2052 lights in response to the low level signal. The buzzer 211 sounds in response to the low level signal. Consequently, there is only one signal line required to represent the normal rotation operation and the abnormal rotation operation.

The frequency signal 200 as mentioned in the previous paragraph is shown as a square wave. A reason for the square wave is that when the fan 1 is rotating, the photoelectric sensing unit 201 receives the light beam 3 reflected by the fan 1 and the blades of the fan 1 reflect the light to the photoelectric sensing unit 201. At the same time, gaps between the blades of the fan do not reflect the light to the photoelectric sensing unit 201. Consequently, the photoelectric sensing unit 201 can generate a frequency signal 200 like the square wave according to the reflection of the light.

The processing unit 203 can be a signal processing chip of model number PIC16F873A. The photoelectric sensing unit 201 is a single-side photoelectric transceiver with both the transmitter side and receiver side fabricated on the same component. The photoelectric sensing unit 201 can also comprise a signal transmitter and a signal receiver. The display unit 209 can have various kinds of display components, such as a seven-segment display, a liquid crystal display, or similar, for showing the rotation speed. The power regulation unit 215 can be a voltage regulator of model number LM7812CT or LM7805CT manufactured by National Semiconductor Corporation. As show in FIG. 2, when the display unit 209 utilizes a seven-segment display 2091 to display the rotation speed, the display unit 209 further comprises a display driver unit 2092 for converting the rotation speed signal 202 outputted by the processing unit 203 into a signal for the 7-segment display, wherein the display unit 2092 can be a display driver chip of model number of 74HC164.

The first embodiment only discloses one example for detecting whether the rotation speed of the fan is normal or not by utilizing optical detection. The detection apparatus of the present invention can further comprise different kinds of prompt units and display units to provide for different developments and requirements.

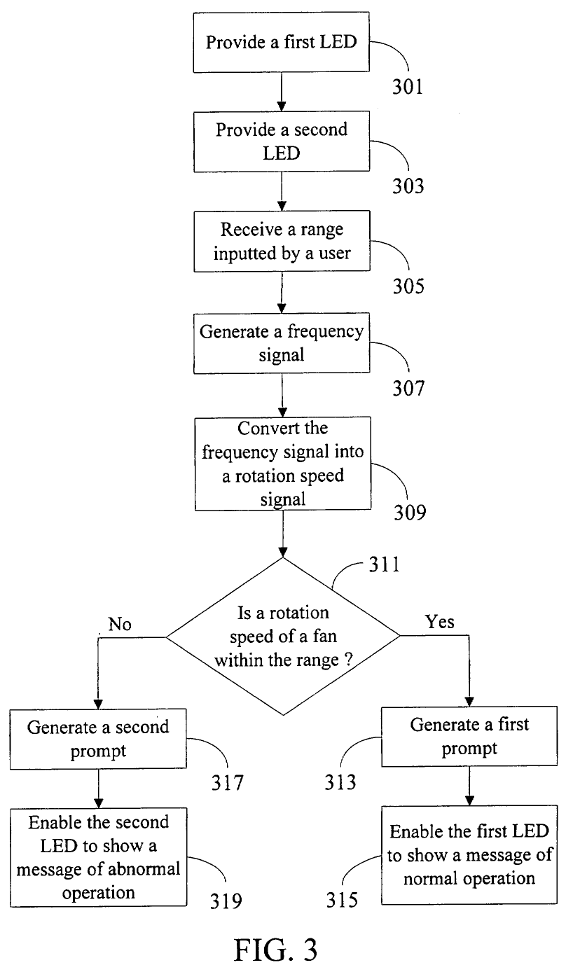

A second embodiment of the invention is a method for detecting a rotation speed of a fan. The method is applied to the detection apparatus 2 described in the first embodiment. As shown in FIG. 3, the method comprises the following steps. Step 301 is executed for providing a first LED 2051. Step 303 is executed for providing a second LED 2052. Step 305 is executed for receiving the range inputted by a user, and storing the range into the detection apparatus 2. Step 307 is executed for sensing the strength of a light beam reflected in response to the rotation of the fan to generate a frequency signal. Step 309 is executed for converting the frequency signal into a rotation speed signal. Step 311 is executed for determining whether the rotation speed is within the range inputted by the user in response to the rotation speed signal. If yes, step 313 is executed for generating a first prompt signal. Then step 315 is executed in response to the first prompt signal, enabling the first LED 2051 to show a message of normal operation. If the rotation speed of the fan is determined not to be within said range in step 311, step 317 is executed for generating a second prompt signal. Then step 319 is executed in response to the second prompt signal, enabling the second LED 2052 to show a message of abnormal operation.

In addition to the steps shown in FIG. 3, the second embodiment is capable of executing all the operations in the first embodiment. Those skilled in the art can straightforwardly realize how the second embodiment performs these operations and functions based on the above descriptions of the first embodiment; thus, no unnecessary detail is given here.

The detection apparatus of the present invention is small, light weight, convenient, and can test fans with a various number of blades and a detectable rotation speed ranging from 0 to 99999 RPM to fulfill current test requirements in the market since a full rotation speed of a fan is currently under 20000 RPM. Accordingly, the present apparatus enhances detection effectiveness and speed, as well as reduces the chances for inaccuracies.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A detection apparatus for detecting a rotation speed of a fan, comprising:
a photoelectric sensing unit for sensing strength of a light beam reflected in response to a rotation of the fan to generate a frequency signal;
a processing unit for converting the frequency signal into a rotation speed signal, determining whether the rotation speed is within a range in response to the rotation speed signal, generating a first prompt signal if yes, and generating a second prompt signal if no; and
a prompt unit for showing a message of normal operation in response to the first prompt signal and showing a message of abnormal operation in response to the second prompt signal.

2. The detection apparatus as claimed in claim 1, wherein the prompt unit comprises a first light emitting diode (LED) and a second LED.

3. The detection apparatus as claimed in claim 2, wherein showing a message of normal operation is to enable the first LED.

4. The detection apparatus as claimed in claim 2, wherein showing a message of abnormal operation is to enable the second LED.

5. The detection apparatus as claimed in claim 1, further comprising an input unit for a user to determine the range.

6. The detection apparatus as claimed in claim 1, further comprising a display unit for displaying the rotation speed in response to the rotation speed signal.

7. The detection apparatus as claimed in claim 1, wherein the photoelectric sensing unit is a single-end photoelectric transceiver.

8. The detection apparatus as claimed in claim 1, wherein the frequency signal is a square wave signal.

9. A method for detecting a rotation speed of a fan, comprising the steps of:
sensing strength of a light beam reflected in response to a rotation of the fan to generate a frequency signal;
converting the frequency signal into a rotation speed signal;
determining whether the rotation speed is within a range in response to the rotation speed signal;
generating a first prompt signal if the rotation speed is within the range;
generating a second prompt signal if the rotation speed is not within the range;
showing a message of normal operation in response to the first prompt signal; and
showing a message of abnormal operation in response to the second prompt signal.

10. The method as claimed in claim 9, further comprising the step of:
providing a first LED;
wherein the step of showing a message of normal operation is to enable the first LED.

11. The method as claimed in claim 9, further comprising the step of:
providing a second LED;
wherein the step of showing a message of abnormal operation is to enable the second LED.

12. The method as claimed in claim 9, further comprising the step of:
determining the range.

13. The method as claimed in claim 9, further comprising the step of:
displaying the rotation speed in response to the rotation speed signal.
